(19) United States
(12) Patent Application Publication
(10) Pub. No.: US 2014/0369060 A1
(43) Pub. Date: Dec. 18, 2014

(54) LED Signal Lamp

(71) Applicant: Wenhu ZHANG, Shanghai (CN)

(72) Inventor: Wenhu Zhang, Shanghai (CN)

(21) Appl. No.: 14/365,994

(22) PCT Filed: Jul. 26, 2013
(86) PCT No.: PCT/CN2013/080162

§ 371 Date: Jun. 16, 2014

(30) Foreign Application Priority Data
Jul. 27, 2012 (CN) 20120264965.2
Jul. 27, 2012 (CN) 201220370215.9

(51) Int. Cl. F21S 8/10; F21V 9/08

(52) U.S. Cl. CPC F21S 48/215; F21V 9/08; F21Y 2101/02
USPC 362/542; 29/592.1

(57) ABSTRACT

An LED signal lamp which includes at least one white LED illumination unit, and at least one light filter each is provided in a light path of each of the white LED illumination unit for filtering at least one portion of light beams of the white LED illumination unit to provide nonwhite light beams of a predetermined color. Thus colored signal lamp is provided via white LED illumination units, the light efficiency is enhanced, the structure is simple, and the manufacturing costs are low.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a signal lamp, and more particularly to a signal lamp which uses one or more white LEDs as a light source.

2. Description of Related Arts

A signal lamp such as an emergency vehicle lighting and a pharos generally give an alarm or send a signal to people by colorful lights. For example, a vehicle of the police or firemen generally uses emergency vehicle lighting with red and blue lighting that follow each other in rotation or, alternatively, just uses red lighting. The lighting used during an emergency construction may be yellow warning lamps. An ambulance is generally provided with blue signal lamps. In order to enhance the warning effect, police vehicles can be provided with flashing lighting. More specifically, a spinning mirror which is powered by an electric motor is provided around a bulb for creating rotating beams of light, or a flash light circuit is provided in a chip of the lamp, so that the lamps appear to flash when viewed.

Recently, LED lighting has become a new light source besides incandescent lamps, fluorescent lamps, and gas discharge lamps. LED lighting has many advantages in comparison with other lighting sources, such as its low voltage, long lifespan, small volume, light weight, fast response, no radiation, no pollution, and durable in bad working conditions. Therefore, the development of LED lighting as the light source of the signal lamps has become a new trend.

A signal lamp is generally identified by its colorful light and a warming effect that can be performed by the colorful light. For example, a conventional LED signal lamp may use a red chip, a blue chip, or a yellow chip which is encapsulated in a transparent housing for producing corresponding red light, blue light, or yellow light. However, the current industry has focused on the development of white LEDs and little research is made on the red chips, blue chips, and the yellow chips. In other words, a white LED has been developed to have a relatively high effective luminous flux and the value is still increasing. However, the effective luminous flux of these colored chips still remains at a relatively low level, and therefore, it is not efficient to use colored chips to provide colored lightings.

In addition, current research has mainly focused on increasing the luminous flux of the LED chips, the physical structure of the LED lamp has not been modified for reducing the light loss. In other words, the current research seldom optimizes the structure of the LED lamp to reduce the blind illumination areas so as to gather light beams and increase the light efficiency of the LED lamps.

### SUMMARY OF THE PRESENT INVENTION

The main object of the present invention is to provide an LED signal lamp which uses white LEDs as its light source, wherein a light path of the light source with white LEDs is provided with a light filter arranged for filtering at least a portion of light beams of the white LEDs into non-white light beams, so that white LEDs can be used for forming non-white signal lamps.

Another object of the present invention is to provide an LED signal lamp which comprises a plurality of rows of successively arranged white LEDs and a plurality of corresponding rows of light filters, so that the plurality of rows of white LEDs is capable of providing evenly distributed light beams.

Another object of the present invention is to provide an LED signal lamp, wherein each light filter is provided in front of a corresponding white LED illumination unit at a position that the light filter is capable of condensing light beams of the white LED illumination unit, so that a light condensing effect is provided. Simultaneously, the light filter is also a filtering lens which is arranged for filtering the white light beams of the white LED illumination unit to yield colored light beams. In other words, the light filter is provided with two functions: light condensing and light filtering functions.

Another object of the present invention is to provide an LED signal lamp, wherein each white LED illumination unit is provided with a light filter and a light reflecting surface which are arranged for collecting the light beams, so that light intensity is enhanced in comparison with a signal lamp with colored LED illumination units.

Another object of the present invention is to provide an LED signal lamp, in comparison with the conventional art in which colored chips provide a light source and a transparent housing is provided for meeting the requirement of a high luminous flux so as to reduce the attenuation, the LED signal lamp of the present invention can be provided with a colored housing corresponding to the predetermined color of the colored chip, so that the light beams projected from the white LED illumination unit pass through a colored light distributor (colored housing) to provide colored light beams of relatively high purity. In addition, the colored housing itself can perform a decoration and warning effect.

Another object of the present invention is to provide an LED signal lamp, in comparison with the conventional art in which colored chips such as yellow chips provide a light source, the attenuation will be about 50% in thirty minutes, that is a rare attenuation for the white LEDs when the white LEDs are employed to used as light source of the LED signal lamp of the present invention, so that the LED signal lamp of the present invention is capable of obtaining a relatively high light intensity.

Another object of the present invention is to provide an LED signal lamp, wherein white LED illumination units are introduced for replacing the colored LED illumination units such as red LED illumination units, blue LED illumination units, and yellow LED illumination units, the structure is simple, the manufacturing process is easy, and the manufacturing costs are low.

Additional advantages and features of the invention will become apparent from the description which follows, and may be realized by means of the instrumentalities and combinations particular pointed out in the appended claims.

According to the present invention, the foregoing and other objects and advantages are attained by an LED signal lamp comprising at least one white LED illumination unit, and at least one light filter each is provided in a light path of each of the white LED illumination unit for filtering at least one portion of light beams of the white LED illumination unit to provide non-white light beams of a predetermined color.

According to an embodiment of the present invention, the light filter is provided at a position in the light path of each of the white LED illumination unit allowing the light filter to perform a light condensing effect, wherein the light filer is capable of performing both a light filtering effect and the light condensing effect.

According to an embodiment of the present invention, the light filter comprises a lens which is capable of condensing light beams.

According to an embodiment of the present invention, the LED signal lamp further comprises at least one light reflecting surface for reflecting another portion of light beams of the corresponding white LED illumination unit.

According to an embodiment of the present invention, the another portion of light beams of the white LED illumination unit reflected by the light reflecting surface and the portion of the light beams of the white LED illumination unit filtered by the light fitter project in a same direction, so that a light condensing effect is provided.

According to an embodiment of the present invention, the light reflecting surface is a structure selected from a group consisting of a first structure and a second structure, wherein in the first structure, each of the white LED illumination units is provided with a light reflecting device, wherein the light reflecting surface is an inner surface of the light reflecting device, wherein in the second structure, each of the white LED illumination units is provided with a heat dissipating device, wherein the light reflecting surface is an inner surface of the heat dissipating device.

According to an embodiment of the present invention, the LED signal lamp further comprises a housing which includes a light distributor allowing light beams of predetermined color to pass through.

According to an embodiment of the present invention, the light distributor is further used for distributing a direction of the light beams.

According to an embodiment of the present invention, at least one mounting element is provided for mounting the each of the light filters and the corresponding heat dissipating device and the light distributor in position.

According to an embodiment of the present invention, the predetermined color is selected from a group consisting of red, blue, yellow, green, and purple.

According to an embodiment of the present invention, the light filter is selected from a group consisting of a convex lens and a Fresnel lens which is capable of providing light filtering effect.

According to an embodiment of the present invention, the light filter is selected from a group consisting of a vehicle emergency lighting, a warning lamp, a pharos, a ship navigation lighting, and a building aero obstruction lighting.

According to an embodiment of the present invention, the LED signal lamp comprises a plurality of the white LED illumination units, wherein the plurality of white LED illumination units are arranged to form a plurality of rows of white LED illumination units, wherein lines of the plurality of rows of white LED illumination units are intersected to form a polygonal shape, wherein each row of white LED illumination units comprises one or more of the white LED illumination units.

According to an embodiment of the present invention, the LED signal lamp further comprises a control module arranged for selectively turning on and off the plurality rows of white LED illumination units so as to provide a predetermined signal lighting pattern of the LED signal lamp.

According to an embodiment of the present invention, the control module selectively clockwise and counterclockwise turn on the plurality of rows of white LED illumination units to provide a flashing lighting effect.

According to an embodiment of the present invention, the control module controls have at least one row of white LED illuminating units of the plurality of rows of white LED illuminating units turned on so as to keep a signal lighting of the LED signal lamp from not being interrupted.

According to an embodiment of the present invention, the control module controls the operation of the plurality of rows of white LED illumination units to provide an illumination of an angle range selectively from a group consisting of 30°, 45°, 60°, 90°, 120°, and 180°.

The present invention further provides a method of manufacturing an LED signal lamp comprising the following steps.

(a) Project white light beams via at least one white LED illumination unit.

(b) Filter at least one portion of the white beams to harvest non-white light beams.

The present invention further provides an LED signal lamp comprising at least one LED illumination unit, and at least one light processer each provided in a light path of each of the white LED illumination unit for condensing at least one portion of light beams of the white LED illumination unit before the light beams project to outside.

According to an embodiment of the present invention, the LED signal lamp further comprises at least one light reflecting surface for reflecting another portion of light beams of the corresponding white LED illumination unit, wherein another portion of light beams of the white LED illumination unit reflected by the light reflecting surface and the portion of the light beams of the white LED illumination unit filtered by the light fitter project in the same direction.

According to an embodiment of the present invention, the LED illumination unit is a white LED illumination unit, wherein the light processer is further provided with a light filtering effect for filtering the at least one portion of light beams of the white LED illumination unit to provide non-white light beams of a predetermined color.

According to an embodiment of the present invention, the light processer is selected from a group consisting of a convex lens and a Fresnel lens which is capable of providing a light filtering effect, wherein the light filter is provided at a position in the light path of each of the white LED illumination units allowing the light filter to provide a light condensing effect, wherein the light filer is capable of performing both a light filtering effect and the light condensing effect.

According to an embodiment of the present invention, the light processer is selected from a group consisting of a convex lens and a Fresnel lens which is capable of providing a light filtering effect, wherein the LED illumination unit is selected from a group consisting of a white LED illumination unit, a yellow LED illumination unit, a red LED illumination unit, a blue LED illumination unit, a green LED illumination unit and a purple LED illumination unit.

According to an embodiment of the present invention, the plurality of white LED illumination units are arranged to form a plurality of rows of white LED illumination units, wherein lines of the plurality of rows of white LED illumination units are intersected to form a polygonal shape so as to provide a radial illumination.

According to an embodiment of the present invention, the lines of the plurality of rows of white LED illumination units are intersected to form a regular polygonal shape.

According to an embodiment of the present invention, the predetermined color is selected from a group consisting of red, blue, yellow, green, and purple.

According to an embodiment of the present invention, the light reflecting surface is a structure selected from a group consisting of a first structure and a second structure, wherein in the first structure, each of the white LED illumination units is provided with a light reflecting device, wherein the light reflecting surface is an inner surface of the light reflecting device, wherein in the second structure, each of the white LED illumination units is provided with a heat dissipating device, wherein the light reflecting surface is an inner surface of the heat dissipating device.

According to an embodiment of the present invention, the LED signal lamp further comprises a housing which includes a light distributor allowing light beams of predetermined color to pass through and to be evenly distributed.

The LED signal lamp of the present invention may employ an LED member which is specially packaged to provide light beams of a predetermined color other than white. Therefore, according to another aspect of the present invention, the present invention provides an LED signal lamp comprising: at least one LED member serving as a light source, wherein each of the LED members comprises at least one white LED illumination unit, wherein the white LED illumination unit is packaged in the corresponding LED member in such a manner that light beams projecting out from the LED member are light beams of a predetermined color other than white, so that the LED signal lamp is capable of providing desired colored light beams.

According to an embodiment of the present invention, each of the white LED illumination units is provided with a transparent package member which has a color filtering effect, wherein white light beams emitting from the white LED illumination unit are filtered by the corresponding colored transparent package member so as to harvest light beams of the predetermined color.

According to an embodiment of the present invention, the LED signal lamp further comprises at least one light condenser and at least one light reflector, wherein the light condenser is provided at a position in a light path of the LED member in such a manner that the light condenser is capable of providing a light condensing effect, wherein a portion of the light beams projecting out from the LED members is reflected by the light reflector, wherein another portion of the light beams projecting out from the LED members is condensed by the light condenser, wherein both of the first and second portion of the light beams projecting out from the LED members are collected to substantially project along a same direction, so that a light collecting effect is provided.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded view of an LED signal lamp according to a first preferred embodiment of the present invention.

FIG. 2 is a schematic view illustrating the outer appearance of the LED signal lamp according to the above preferred embodiment of the present invention.

FIG. 3 is a sectional view of the LED signal lamp according to the above to preferred embodiment of the present invention.

FIG. 4 is a schematic view illustrating an internal structure of the LED signal lamp according to the above preferred embodiment of the present invention.

FIG. 5 is a sectional view of the LED signal lamp illustrating the lighting beams from the white LED illumination units being collected and filtered into light beams with desired color according to the above preferred embodiment of the present invention.

FIG. 6A is an enlarged partial view of an LED signal lamp according to a second preferred embodiment of the present invention.

FIG. 6B is an enlarged partial view of an LED signal lamp according to an alternative mode of the second preferred embodiment of the present invention.

FIG. 7 is an exploded view of an LED signal lamp according to a third preferred embodiment of the present invention.

FIG. 8 is a schematic view illustrating the outer appearance of the LED signal lamp according to the above third preferred embodiment of the present invention.

FIG. 9 is a sectional view of the LED signal lamp according to the above third preferred embodiment of the present invention.

FIG. 10 is a schematic view illustrating an internal structure of the LED signal lamp according to the above third preferred embodiment of the present invention.

FIG. 11 is a sectional view of the LED signal lamp illustrating the lighting beams from the white LED illumination units being collected and filtered into light beams with desired color according to the above preferred embodiment of the present invention.

FIG. 12 is an enlarged partial view of an LED signal lamp according to a fourth preferred embodiment of the present invention.

FIG. 13 is an enlarged partial view of an LED signal lamp according to an alternative mode of the above fourth preferred embodiment of the present invention.

FIG. 14 is a perspective view of an LED signal lamp according to a fifth preferred embodiment of the present invention.

FIG. 15 is a schematic view illustrating the internal structure of the LED signal lamp according to the above preferred embodiment of the present invention.

FIG. 16 is a schematic view illustrating the LED member of LED signal lamp according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

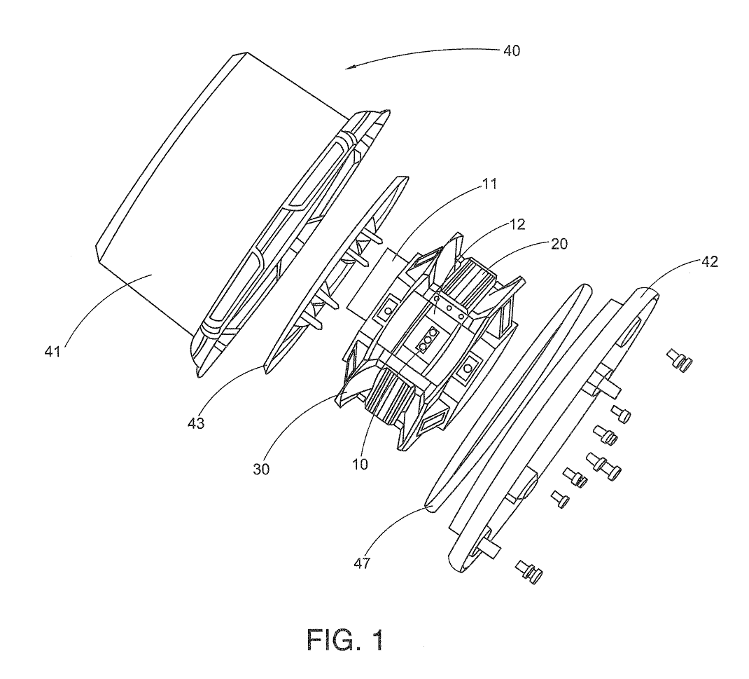

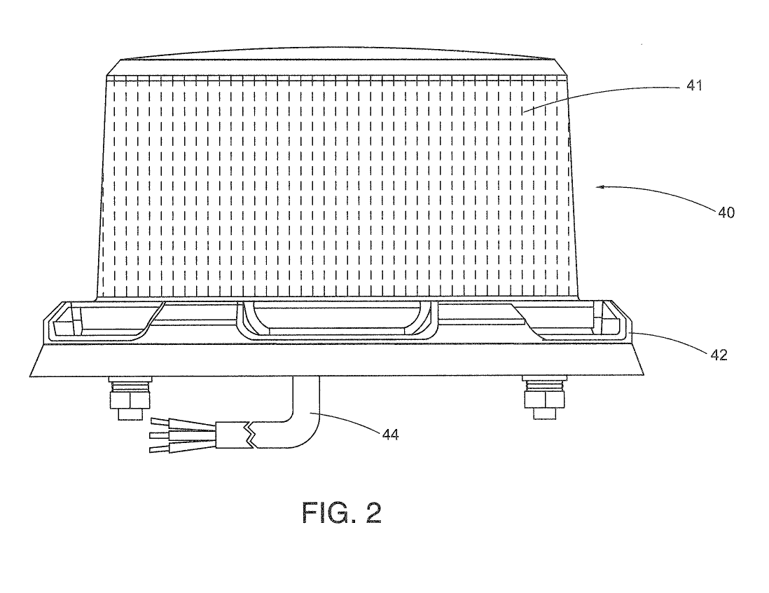

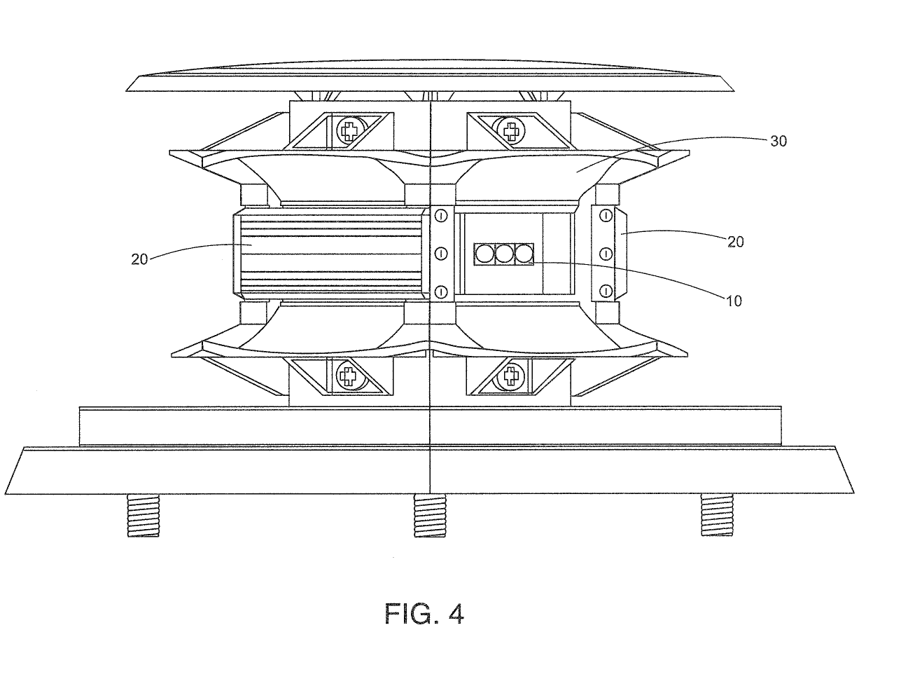

Referring to FIGS. 1 to 5 of the drawings, an LED signal lamp according to a first preferred embodiment of the present invention is illustrated. The LED signal lamp according to this preferred embodiment of the present invention can be embodied as emergency vehicle lighting (a warning lamp) which comprises a plurality of light sources and a plurality of light filters 20 respectively provided in light paths of the light sources.

According to the present invention, the plurality of light sources can be embodied as a plurality of white LED illumination units 10. The plurality of white LED illumination units 10, which is accessible in the market, commercially available white LED illumination units of single chip type or multichip type. The plurality of light filters 20 is respectively provided in light paths of the plurality of white LED illumination units 10. For example, each of the plurality of light filters 20 is provided at one side of each of the plurality of white LED illumination units 10 so as to filter at least a portion of white light beams of each white LED illumination unit 10 into light beams which are not white colored, so that a non-white colored signal lamp is formed. According to this preferred embodiment, the plurality of light filters 20 can filter at least a portion of the light beams of the plurality of white LED illumination units 10 respectively to obtain single colored light beams such as red, blue, green, yellow, and purple light beams, so that red, blue, green, yellow, or purple LED signal lamps can be provided. As an example, the plurality of light filters 20 of this preferred embodiment filters at least a portion of the light beams of the plurality of white LED illumination units 10 respectively to obtain red or yellow warning lamps.

The principle of the colored signal lamp of the present invention is to filter the light beams of the plurality of white LED illumination units 10 so as to obtain colored signal lighting. A high quality light source of white LED illumination units is easy to obtain from the market. In comparison with the conventional art in which colored LED illumination units are directly used as the light source, the LED lamp of the present invention is easier to obtain at a relatively high light intensity while the costs are low. For example, a white LED illumination unit with a luminous flux about 150 lm is easy to obtain in the market, when the light beams of the white LED illumination unit is filtered to provide colored light beams via the light filter 20, the obtained colored light beams still have a light intensity which is significantly larger than a light intensity of a conventional signal lamp which uses colored LED chips as the light source. For example, in the yellow warning lamp of the present invention, the light beams may be filtered by the light filter 20 to obtain yellow light beams which is about 60% of the total light beams of the yellow warning lamp, the obtained luminous flux of the yellow beams is about 90 lm which is still significantly higher than the luminous flux of the commercially available yellow LED illumination unit which is about 50˜60 lm.

The terms “filter, filtered, and filtering” of the present invention are referred to a process in which the light beams of the white LED illumination units 10 are respectively processed by the plurality of light filters 20 to obtain light beams of a single predetermined color which is not white colored. The predetermined color may be red, blue, green, yellow and the like.

Since each white LED illumination units 10, which can be accessed from the market, already has a relatively high luminous flux, and the research on the white LED illumination units is ongoing, thus the luminous flux of the white LED illumination units 10 can be further increased. However, little research has been made on the colored LED illumination units and the luminous flux of the colored LED illumination units is therefore still maintained at a relatively low level. Therefore, when the white LED illumination units are used as light source of colored light signal lamp, the white LED illumination units of high luminous flux are easy to obtain from the market, making the manufacturing process is easy.

It is worth mentioning that the LED signal lamp of the present invention can comprise at least two arrows of white LED illumination units 10. For example, the LED signal lamp may comprise three rows, four rows, six rows, eight rows, or twelve rows of the white LED illumination units 10. Each row of the white LED illumination units 10 may comprise one or more white LED illumination units 10. Therefore, the plurality of rows of white LED illumination units are successively arranged in such a manner that the lines of the plurality of rows of white LED illumination units 10 may be intersected with each other to form an equilateral triangular shape, a square shape, a regular hexagonal shape, a regular octagonal shape, a regular dodecagonal shape, or other regular polygonal shapes. It is worth mentioning that the plurality of white LED illumination units 10 may not be arranged to form a regular polygonal shape so as to provide a LED signal lamp which provides a lighting of a circular section shape rather than a circular radial lighting. The present invention is not limited in this aspect, and the shapes may be varied according to different actual requirements.

It is thus can be seen that when the number of the rows of the plurality of the white LED illumination units 10 increases, the light beams of the white LED illumination units 10 will become more evenly and radially distributed. The brighter light beams and the darker light beams will overlap with each other to the utmost extent so that a 360° angled evenly distributed lighting is provided. Therefore, the signal lamp of the present invention can be an LED signal lamp with radial lighting. The term “radial lighting” refers to a pattern of lighting in which the light beams radially project from the light source and are arranged circumferentially. Preferably, the white LED illumination units are arranged to provide 360° light beams. Alternatively, one or more rows of the white LED illumination units 10 of the plurality of rows of the white LED illumination units 10 may be eliminated according to actual requirements so that one or several directions of the signal lamp is not provided with lighting. In other words, the LED signal lamp of the present invention can provide circular sector shaped or semicircular shaped lighting, such as a lighting of a range of 180° or 270°.

It is worth mentioning that the plurality of light filters 20 corresponding to the white LED illumination units 10 can filter the light beams of the white LED illumination units to obtain different colored light beams. For example, three rows of the six rows of the white LED illumination units 10 are provided with red light filters 20, and the other three rows of the six rows of the white LED illumination units 10 are provided with blue light filters 20. The LED signal lamp may be further provided with a control center 11 which selectively turns on the six rows of white LED illumination units 10 so as to selectively provide red lighting, blue lighting, and red and blue lightings which follow each other in rotation. In this example, the housing of the LED lamp can be a transparent housing.

In this preferred embodiment, as an example, the warning lamp comprises six rows of the white LED illumination units 10. Each row comprises three white LED illumination units 10. Each of the three white LED illumination units 10 is provided with a light filter 20 in a light path thereof for filtering at least a portion of light beams of the white LED illumination unit 10 so as to obtain yellow lighting, so that a yellow warning lamp is provided.

It is thus can be seen that in the above example of the yellow warning lamp, the control center 11 selectively turns on or turn off the white LED illumination units 10, or turns on the white LED illumination units 10 at a predetermined time interval so as to provide a yellow flash lighting, thus addition view impact effect is provided to enhance the warning effect.

The plurality of light filters 20 is respectively provided at a suitable position adjacent to the plurality of white LED illumination units 10. Preferably, in this preferred embodiment, the plurality of light filters 20 are innovatively designed to perform a light condensing effect. In other words, each light filter 20 is capable of collecting light beams of the corresponding white LED illumination unit 10 while simultaneously is capable of filtering the light beams so as to obtain non-white light beams.

In other words, the light filters 20 of the present invention not only perform a light filtering effect but also perform a light condensing effect. It is worth mentioning that after the light condensing process, the effective luminous flux reaching to the desired areas is increased, so that the light intensity of the LED lamp is enhanced.

Each of the light filters 20 can be a lens which can provide a light condensing effect, such as a convex lens. Accordingly, as an example, each of the light filters 20 can be a Fresnel lens which has a light filtering function, so that the light beams of each white LED illumination unit 10 are collected and focused via the Fresnel lens and are further filtered to provide light beams of predetermined color rather than white. The processed light beams project substantially in parallel directions, so that light efficiency is increased, the predetermined areas, where the light beams reach to, can have a relatively high luminous flux.

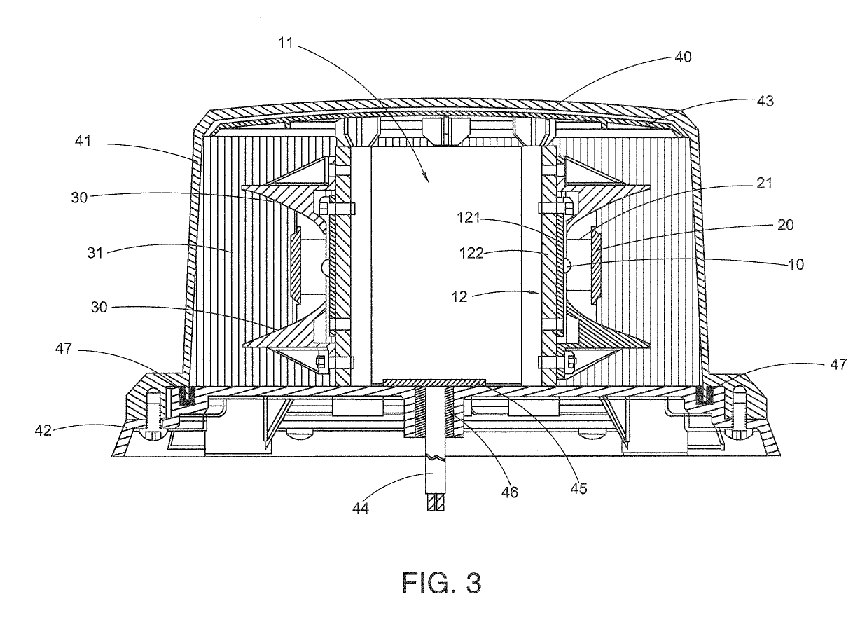

Each of the light filters 20 is provided at a suitable position in front of corresponding white LED illumination unit 10. A shape and size of each light filter 20 can be varied according to requirements so as to obtain a maximum light condensing effect. Obvious brighter spots can also be eliminated. In this example, each light filter 20 is provided with at least one mounting element 21, so that each light filter 20 is fit to a suitable position in the light path of the white LED illumination unit 10 via the mounting element 21. For example, each light filter 20 can be mounted with the corresponding mounting element 21 via screws. In addition, the LED signal lamp is further provided with a plurality of heat dissipating devices 12. The mounting element 21 is provided between the heat dissipating device 12 and the light filter 20 so as to connect the heat dissipating device 12 with the light filter 20. The installation of the light filters 20 can be achieved by other methods as long as the light filters 20 are capable of providing light condensing and light filtering effect. Each heat dissipating device 12 comprises a metal heat dissipating panel 121 and a plurality of heat dissipating fins 122 connected to the heat dissipating panel 121. The heat dissipating panel 121 and the plurality of heat dissipating fins 122 can be made of metal materials. Referring to FIG. 3 of the drawings, each white LED illumination unit 10 is mounted on the corresponding heat dissipating panel 121.

As shown in FIG. 3 of the drawings, it is worth mentioning that each white LED illumination unit 10 is provided in a receiving chamber 31 defined by a light reflecting surface 30. The light reflecting surface 30 and the light filter 20 cooperate to gather light beams of each white LED illumination unit 10. The light reflecting surface 30 may provide a bar type parabolic surface, so that the light beams reflected by the light reflecting surface 30 and the light beams gathered by the light filter 20 are collected to form light beams projecting to parallel directions, as shown in FIG. 3, a gap may be formed between the light reflecting surface 30 and the light filter 20 in such a manner that a portion of the light beams passes through the gap to reach the light reflecting surface 30 and is reflected by the light reflecting surface 30 without processing by the light filter.

Each light reflecting surface 30 may be an inner surface of a light reflecting device, as shown in FIG. 3, the light reflecting surface can be parabolic cured surface. The shape can be optimized to obtain a desired reflecting effect according to the requirements, so that the light reflecting surface 30 can cooperate with the light filter 20 (Fresnel lens) to obtain a desired best light condensing effect.

It is worth mentioning that when the white LED illumination units 10 are able to provide an enough light illumination, the light reflecting surface 30 can only be used for reflecting the light beams without performing the light condensing effect.

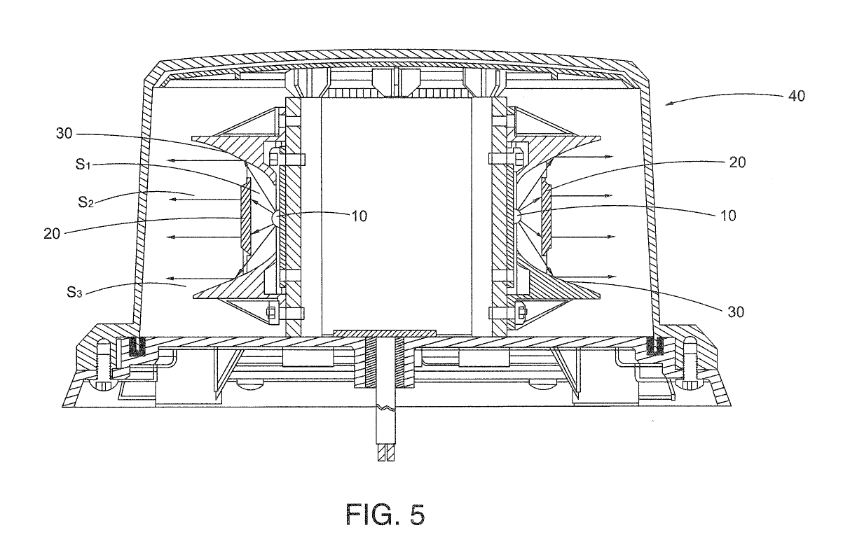

Referring to FIG. 5 of the drawings, when one of the white LED illumination units 10 is in operation to produce white light beams, a portion of white beams, which passes through the corresponding light filter 20 (Fresnel lens), is gathered by corresponding light filter 20 (Fresnel lens) and filtered to obtain single colored light beams, as shown in the drawings, the light beams, which are radially projected from each white LED illumination unit 10 serving as a light source center, reach to S1 zone which is defined between each white LED light illumination unit 10 and corresponding light filter 20 (Fresnel lens). And then, the light beams reach to S2 zone in which the light beams have passed through the corresponding light filter 20 (Fresnel lens), so that the radial white light beams are gathered and directed to form parallelly projecting light beams and the white light beams are filtered to provide colored light beams rather than white light beams.

It is worth mentioning that the LED signal lamp according to this preferred embodiment of the present invention further comprises a housing 40 which comprises a light distributor 41 which filters all of the light beams of the white LED illumination units 10 to harvest light beams of desired color. In other words, the portion of light beams, which passes through the gap between each light filter 20 and light reflecting surface 30 and reflected by the light reflecting surface 30, is filtered into non-white light beams after passing through the light distributor 41. In other words, the light filter 20 and the light distributor 41 are capable of filtering the white light beams of the corresponding white LED illumination unit 10 to obtain non-white light beams with a same color.

It is worth mentioning that the light distributor 41 not only performs the light filtering function, but also optimize the distribution of the light output. In other words, the light beams from all of the light illumination units 10 are evenly distributed to desired areas via the light distributor 41.

Referring to FIG. 5 of the drawings, the light beams reaching to S3 zone which are reflected by the light reflecting surface 30 are preferably directed to project in a direction the same of the direction of light beams which have passed through the light filter 20, so that the light intensity of light beams reaching to the desired areas is enhanced, the light beams which have been reflected by the light reflecting surface 30 are processed by the light distributor 41 to form desired colored light beams.

As an example of the above warning lamp, the light distributor 41 is a yellow lens, so that the portion of light beams, which does not pass through the light filter 20 but is reflected by the light reflecting surface 30, is filtered by the yellow lens. Simultaneously, the main portion of light beams of each white LED illumination unit 10 is filtered by the light filter 20, so that a yellow warning lamp is provided. In addition, the warning lamp can be directly provided with a yellow light distributor. In comparison with the conventional art which has yellow LEDs as a light source and a transparent housing, the warning lamp of the present invention is provided with a colored effect for enhancing the warning effect. It is worth mentioning that the light distributor 41 of the present invention can be directly used as an outer housing of the LED signal lamp of the present invention.

In the LED signal lamp which is embodied as a warning lamp of the present invention, the housing 40 is provided with a base 42. A chamber is defined by the light distributor 41 and the base 42. The plurality of white LED illumination units 10, and the corresponding plurality of light filters 20 and other necessary components are installed in the chamber. A top portion of the housing 40 can be further provided with a decoration housing 43 for adding decorative effect to the LED signal lamp so as to enhance the aesthetic appearance. The housing 40 also comprises a necessary electric wire 44 which is electrically connected to the control center 11 for offering power supply so as to control the operation of the LED signal lamp. The electric wire 44 passes through a sealing panel 45 and is retained in position by sealing glues 46. The light distributor 41 is sealedly connected via a sealing ring 47.

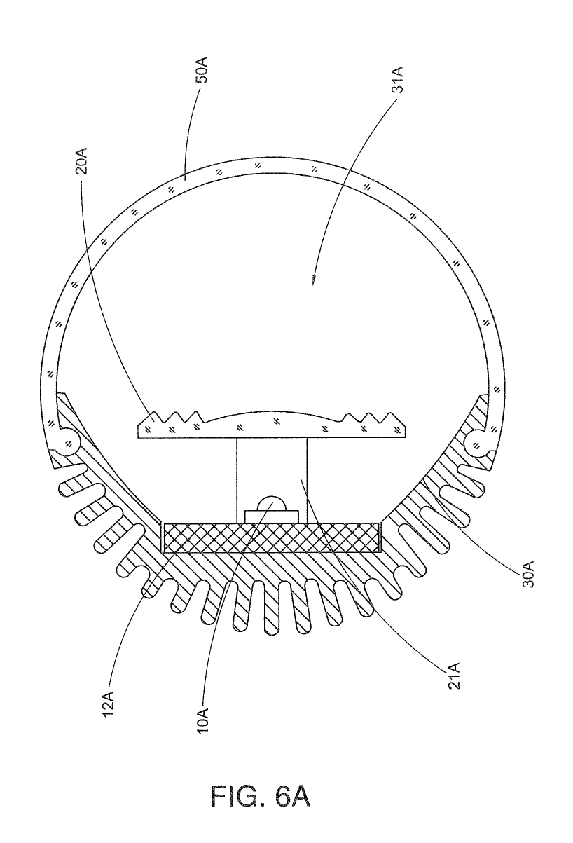

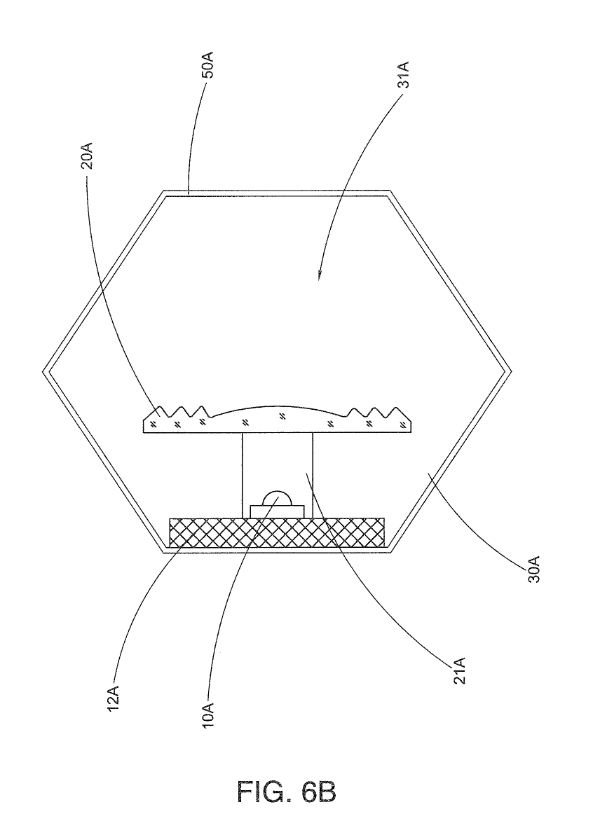

Referring to FIGS. 6A and 6B of the drawings, an LED signal lamp according to a second preferred embodiment of the present invention is illustrated. The LED signal lamp of this preferred embodiment has a structure similar to the structure of the above first preferred embodiment. In this preferred embodiment, the light reflecting surface 30A is an inner surface of the heat dissipating device 12A. In other words, the inner surface of the heat dissipating device 12A is also provided with light reflecting effect, so that the light condensing effect is provided via the cooperation of each light filter 20 and the inner surface of the heat dissipating device 12A, and thus the light beams of each white LED illumination unit are directed to parallel directions. A light filtering housing 50A is also connected to each light reflecting surface 30A for allowing light beams with predetermined color passing therethough. In other words, the light filtering housing 50A, which has a similar function with the light distributor 41 of the above preferred embodiment, is directly coupled with each corresponding light reflecting surface 30A to define a sealed receiving chamber 31A.

Accordingly, the present invention provides an LED signal lamp which comprises one or more light illumination arrangements each comprising a white LED illumination unit 10, a light filter 20, and having a light reflecting surface 30. The white LED illumination unit 10 provides white light beams which are filtered by the corresponding light filter 20 and undergo a light condensing process via the light filter 20 and the light reflecting surface 30, so that colored signal light beams with high illuminating efficiency are provided. These light illumination arrangements can be arranged to provide radially projecting colored light beams so as to provide a radial signal lighting.

The present invention provides a method of manufacturing an LED signal amp which comprises the following steps.

(a) Project white light beams via at least one white LED illumination unit 10.

(b) Filter at least one portion of the white beams to harvest non-white light beams.

The step (a) may further comprise a step (a.1) of: Arrange a plurality of white LED illumination units 10 into a plurality of rows of white LED illumination units 10 in such a manner that the lines of the plurality of rows of white LED illumination units 10 are intersected to form a polygonal shape so as to provide a radial illumination.

In the step (a.1), each row of the white LED illumination units 10 comprises one or more white LED illumination units 10.

In the step (a.1), the lines of the plurality of rows of white LED illumination units 10 are intersected to form a polygonal shape such as an equilateral triangular shape, a square shape, a regular hexagonal shape, a regular octagonal shape, and a regular dodecagonal shape.

The step (b) may comprise a step (b.1) of providing a light filter 20 in a light path of each of the white LED illumination units 10, wherein light beams passing through the light filter 20 is filtered to harvest light beams with a predetermined single color.

In the step (b.1), the light filter can be a Fresnel lens with light filtering effect. The Fresnel lanes may be provided at a location which is capable of condensing light beams so that the light filter 20 performs both light filtering and light condensing effects.

In the step (b.1), the predetermined color can be red, blue, yellow, green, or purple.

The method may further comprise a step (c) of reflecting another portion of the white light beams via a light reflecting surface 30 in such a manner that the reflected white light beams project in a direction substantially the same as a direction of the light beams which pass through the light filter 20.

In the step (c), the light reflecting surface can be a parabolic surface of a light reflecting device or an inner surface of a heat dissipating device 12.

The method may further comprise a step (d) of processing the light beams via a light distributor 41 of a housing 40, wherein the light distributor 41 is an outer lens of a predetermined color, so that the resulted colored light beams are evenly distributed, and the color of the light beams is also enhanced.

The LED signal lamp manufactured by the above method may be a warning lamp (a vehicle emergency lighting), a pharos, a ship navigation lighting, a building aero obstruction lighting, or the like.

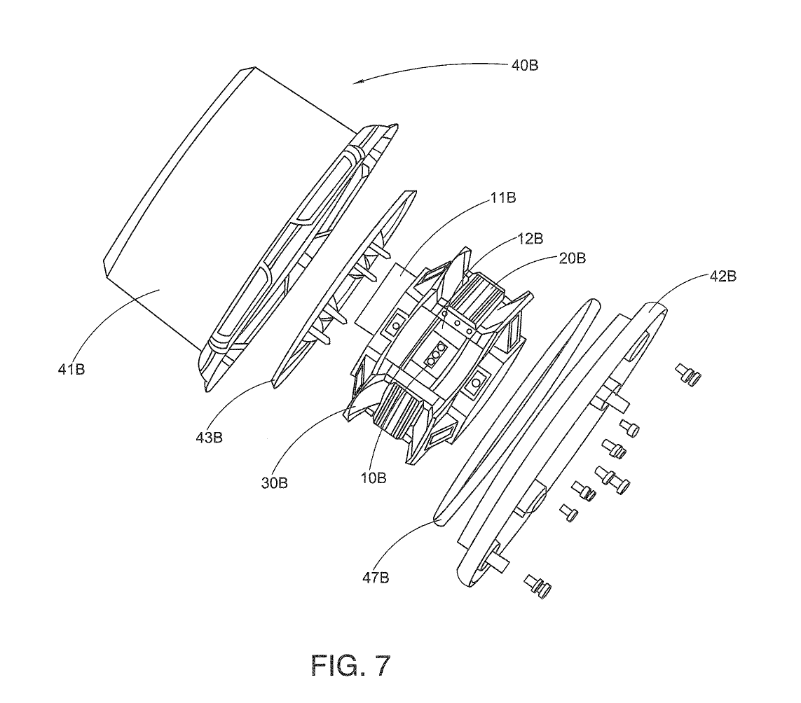

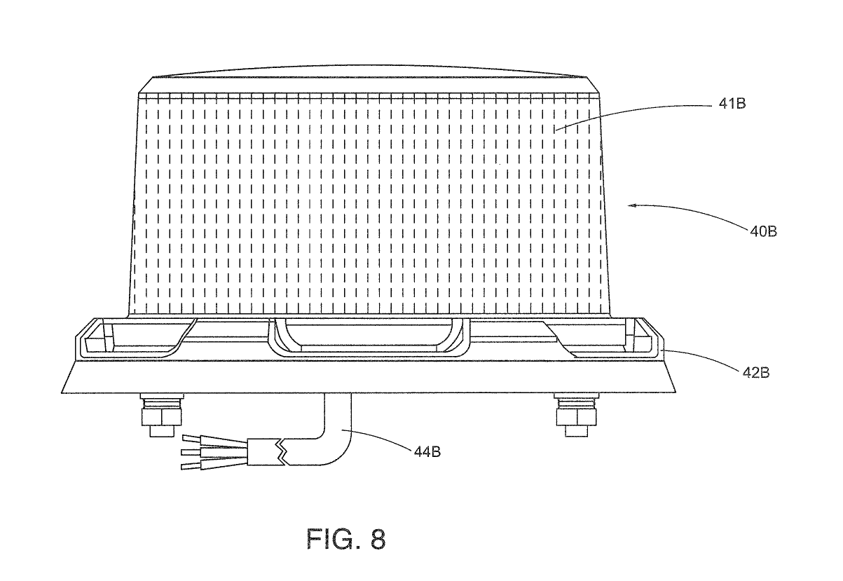

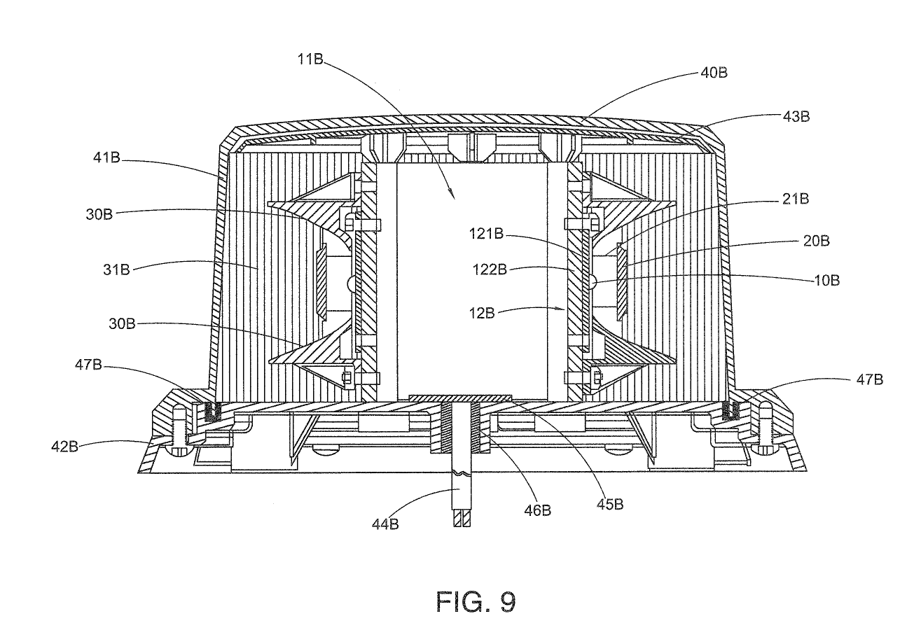

Referring to FIGS. 7 to 11 of the drawings, an LED signal lamp according to a third preferred embodiment of the present invention is illustrated. The LED signal lamp according to this preferred embodiment of the present invention can be embodied as an emergency vehicle lighting (a warning lamp) which comprises a plurality of light sources and a plurality of light processers 20B respectively provided in light paths of each of the light sources.

According to the present invention, the plurality of light sources can be embodied as a plurality of white LED illumination units 10B. The plurality of white LED illumination units 10B, which is accessible in the market, can be commercially available white LED illumination units of single chip type or multichip type. The plurality of light processers 20B is respectively provided in light paths of the plurality of white LED illumination units 10B. For example, each of the plurality of light processers 20B is provided at one side of each of the plurality of white LED illumination units 10B so as to filter at least a portion of white light beams of each white LED illumination unit 10B into light beams which are not white colored, so that a non-white colored signal lamp is formed. According to this preferred embodiment, the plurality of light processers 20B can filter at least a portion of the light beams of the plurality of white LED illumination units 10B respectively to obtain single colored light beams such as red, blue, green, yellow, and purple light beams, so that red, blue, green, yellow, or purple LED signal lamps can be provided. As an example, the plurality of light processers 20B of this preferred embodiment filters at least a portion of the light beams of the plurality of white LED illumination units 10B respectively to obtain red or yellow warning lamps.

The principle of the colored signal lamp of the present invention is to filter the light beams of the plurality of white LED illumination units 10B so as to obtain colored signal lighting. High quality light source of white LED illumination units is easy to obtain from the market. In comparison with the conventional art in which colored LED illumination units are directly used as the light source, the LED lamp of the present invention makes it easier to obtain a relatively high light intensity while the costs are low. For example, a white LED illumination unit with a luminous flux about 150 lm is easy to obtain in the market, when the light beams of the white LED illumination unit is filtered to provide colored light beams via the light processer 20B, the obtained colored light beams still has a light intensity which is significantly larger than a light intensity of a conventional signal lamp which uses colored LED chips as the light source. For example, in the yellow warning lamp of the present invention, the light beams may be filtered by the light processer 20B to obtain yellow light beams which is about 60% of the total light beams of the yellow warning lamp, the obtained luminous flux of the yellow beams is about 90 lm which is stiller significantly higher than the luminous flux of the public-sold yellow LED illumination unit which is about 50˜60 lm.

The terms “filter, filtered, and filtering” of the present invention are referred to a process in which the light beams of the white LED illumination units 10B are respectively processed by the plurality of light processers 20B to obtain light beams of a single predetermined color which is not white colored. The predetermined color may be red, blue, green, yellow and the like.

Since each white LED illumination units 10B which can be accessed from the market already has a relatively high luminous flux, and the research on the white LED illumination units is still going on, thus the luminous flux of the white LED illumination units 10B can be further increased. However, little research is made on the colored LED illumination units and the luminous flux of the colored LED illumination units still maintains a relatively low value. Therefore, when the white LED illumination units are used as light source of colored light signal lamp, the white LED illumination units of high luminous flux are easy to obtain from the market, so that the manufacturing process is easy.

It is worth mentioning that the LED signal lamp of the present invention can comprise at least two arrows of white LED illumination units 10B. For example, the LED signal lamp may comprise three rows, four rows, six rows, eight rows, or twelve rows of the white LED illumination units 10B. Each row of the white LED illumination units 10B may comprise one or more white LED illumination units 10B. Therefore, the plurality of rows of white LED illumination units are successively arranged in such a manner that the lines of the plurality of rows of white LED illumination units 10B may be intersected with each other to form an equilateral triangular shape, a square shape, a regular hexagonal shape, a regular octagonal shape, a regular dodecagonal shape, or other regular polygonal shapes. It is worth mentioning that the plurality of white LED illumination units 10B may not be arranged to form a regular polygonal shape so as to provide a LED signal lamp which provides a lighting of a circular section shape rather than a circular radial lighting. The present invention is not limited in this aspect, and the shapes may be varied according to different actual requirements.

It is thus can be seen that when the number of the rows of the plurality of the white LED illumination units 10B increases, the light beams of the white LED illumination units 10B will become more evenly and radially distributed. The brighter light beams and the darker light beams will overlap with each other to the utmost extent so that a 360° angled even lighting is provided. Therefore, the signal lamp of the present invention can be an LED signal lamp with radial lighting. The term “radial lighting” refers to a pattern of lighting in which the light beams radially project from the light source and are arranged circumferentially. Preferably, the white LED illumination units are arranged to provide 360° light beams. Alternatively, one or more rows of the white LED illumination units 10B of the plurality of rows of the white LED illumination units 10B may be eliminated according to actual requirements so that one or several directions of the signal lamp is not provided with lighting. In other words, the LED signal lamp of the present invention can provide circular sector shaped or semicircular shaped lighting, such as a lighting of a range of 180° or 270°.

It is worth mentioning that the plurality of light processers 20B corresponding to the white LED illumination units 10B can filter the light beams of the white LED illumination units to obtain different colored light beams. For example, three rows of six rows of the white LED illumination units 10B are provided with red light processers 20B, and the other three rows of six rows of the white LED illumination units 10B are provided with blue light processers 20B. The LED signal lamp may be further provided with a control center 11B which selectively turns on the six rows of white LED illumination units 10B so as to selectively provide red lighting, blue lighting, and red and blue lightings which follow each other in rotation. In this example, the housing of the LED lamp can be a transparent housing.

In this preferred embodiment, as an example, the warning lamp comprises six rows of the white LED illumination units 10B. Each row comprises three white LED illumination units 10B. Each of the three white LED illumination units 10B is provided with a light processer 20B in a light path thereof for filtering at least a portion of light beams of the white LED illumination unit 10B so as to obtain yellow lighting, so that a yellow warning lamp is provided.

It is thus can be seen that in the above example of the yellow warning lamp, the control center 11 selectively turns on or turn off the white LED illumination units 10B, or turns on the white LED illumination units 10B at a predetermined time interval so as to provide a yellow flash lighting, thus addition view impact effect is provided to enhance the warning effect.

The plurality of light processers 20B is respectively provided at a suitable position adjacent to the plurality of white LED illumination units 10B. Preferably, in this preferred embodiment, the plurality of light processers 20B is innovatively designed to perform a light condensing effect. In other words, each light processer 20B is capable of collecting light beams of the corresponding white LED illumination unit 10B while simultaneously is capable of filtering the light beams so as to obtain non-white light beams.

In other words, the light processers 20B of the present invention not only perform a light filtering effect but also perform a light condensing effect. It is worth mentioning that after the light condensing process, the effective luminous flux reaching to the desired areas is increased, so that the light intensity of the LED lamp is enhanced.

Each of the light processers 20B can be a lens which can perform light condensing effect, such as a convex lens. Accordingly, as an example, each of the light processers 20B can be a Fresnel lens which has light filtering function, so that the light beams of each white LED illumination unit 10B are collected and focused via the Fresnel lens and are further filtered to provide light beams of a predetermined color rather than white. The processed light beams project substantially in parallel directions, so that light efficiency is increased, the predetermined areas which the light beams reach to have a relatively high luminous flux.

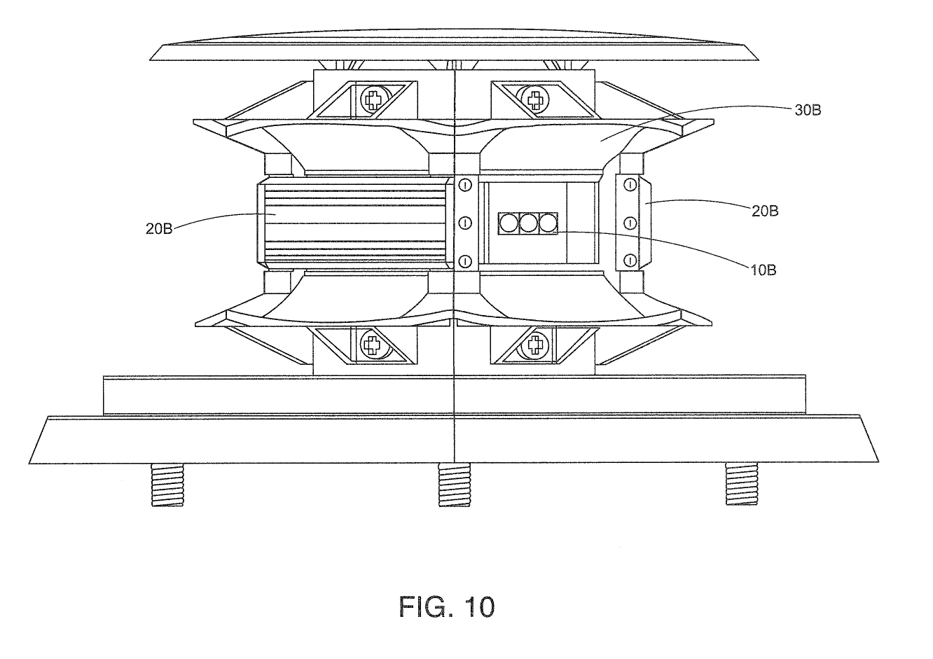

Each of the light processers 20B is provided at a suitable position in front of corresponding white LED illumination unit 10B. A shape and size of each light processer 20B can be varied according to requirements so as to obtain a maximum light condensing effect. Obvious brighter spots can also be eliminated. In this example, each light processer 20B is provided with at least one mounting element 21B, so that each light processer 20B is fit to a suitable position in the light path of the white LED illumination unit 10B via the mounting element 21B. For example, each light processer 20B can be mounted with the corresponding mounting element 21B via screws. In addition, the LED signal lamp is further provided with a plurality of heat dissipating devices 12B. The mounting element 21B is provided between the heat dissipating device 12 and the light processer 20B so as to connect the heat dissipating device 12B with the light processer 20B. The installation of the light processers 20B can be achieved by other methods as long as the light processers 20B are capable of providing light condensing and light filtering effect. Each heat dissipating device 12B comprises a metal heat dissipating panel 121B and a plurality of heat dissipating fins 122B connected to the heat dissipating panel 121B. The heat dissipating panel 121B and the plurality of heat dissipating fins 122B can be made of metal materials. Referring to FIG. 10B of the drawings, each white LED illumination unit 10B is mounted on the corresponding heat dissipating panel 121.

As shown in FIG. 10B of the drawings, it is worth mentioning that each white LED illumination unit 10B is provided in a receiving chamber 31B defined by a light reflecting surface 30B. The light reflecting surface 30B and the light processer 20B cooperate to gather light beams of each white LED illumination unit 10B. The light reflecting surface 30B may provide a bar type parabolic surface, so that the light beams reflected by the light reflecting surface 30B and the light beams gathered by the light processer 20B are collected to form light beams projecting to parallel directions, as shown in FIG. 10B, a gap may be formed between the light reflecting surface 30B and the light processer 20B in such a manner that a portion of the light beams passes through the gap to reach the light reflecting surface 30B and is reflected by the light reflecting surface 30B without processing by the light processer.

Each light reflecting surface 30B may be an inner surface of a light reflecting device, as shown in FIG. 10B, the light reflecting surface can be parabolic cured surface. The shape can be optimized to obtain a desired reflecting effect according to the requirements, so that the light reflecting surface 30B can cooperate with the light processer 20B (Fresnel lens) to obtain a desired best light condensing effect.

It is worth mentioning that when the white LED illumination units 10B are able to provide an enough light illumination, the light reflecting surface 30B can only be used for reflecting the light beams without performing the light condensing effect.

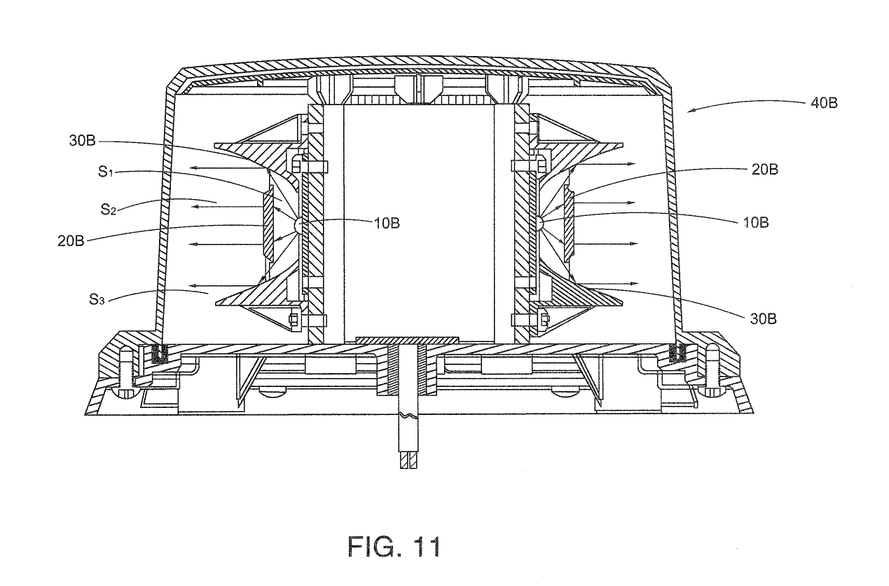

Referring to FIG. 11 of the drawings, when one of the white LED illumination units 10B is in operation to produce white light beams, a portion of white beams, which passes through the corresponding light processer 20B (Fresnel lens), is gathered by corresponding light processer 20B (Fresnel lens) and filtered to obtain single colored light beams, as shown in the drawings, the light beams, which are radially projected from each white LED illumination unit 10B serving as a light source center, reach to S1 zone which is defined between each white LED light illumination unit 10B and corresponding light processer 20B (Fresnel lens). And then, the light beams reach to S2 zone in which the light beams have passed through the corresponding light processer 20B (Fresnel lens), so that the radial white light beams are gathered and directed to form parallelly projecting light beams and the white light beams are filtered to provide colored light beams rather than white light beams.

It is worth mentioning that the LED signal lamp according to this preferred embodiment of the present invention further comprises a housing 40B which comprises a light distributor 41B which filters all of the light beams of the white LED illumination units 10B to harvest light beams of desired color. In other words, the portion of light beams, which passes through the gap between each light processer 20B and light reflecting surface 30B and reflected by the light reflecting surface 30B, is filtered into non-white light beams after passing through the light distributor 41B. In other words, the light processer 20B and the light distributor 41B are capable of filtering the white light beams of the corresponding white LED illumination unit 10B to obtain non-white light to beams with a same color.

It is worth mentioning that the light distributor 41B not only performs the light filtering function, but also optimizes the distribution of the light output. In other words, the light beams from all of the light illumination units 10B are evenly distributed to desired areas via the light distributor 41B.

Referring to FIG. 11 of the drawings, the light beams reaching to S3 zone which are reflected by the light reflecting surface 30B are preferably directed to project in a direction the same of the direction of light beams which have passed through the light processer 20B, so that the light intensity of light beams reaching to the desired direction is enhanced, the light beams which have been reflected by the light reflecting surface 30B are processed by the light distributor 41B to form desired colored light beams.

As an example of the above warning lamp, the light distributor 41B is a yellow lens, so that the portion of light beams, which does not pass through the light processer 20B but is reflected by the light reflecting surface 30B, is filtered by the yellow lens. Simultaneously, the main portion of light beams of each white LED illumination unit 10B is filtered by the light processer 20B, so that a yellow warning lamp is provided. In addition, the warning lamp can be directly provided with a yellow light distributor. In comparison with the conventional art which has yellow LEDs as a light source and a transparent housing, the warning lamp of the present invention is provided with a colored effect for enhancing the warning effect. It is worth mentioning that the light distributor 41B of the present invention can be directly used as an outer housing of the LED signal lamp of the present invention.

In the LED signal lamp which is embodied as a warning lamp of the present invention, the housing 40B is provided with a base 42B. A chamber is defined by the light distributor 41B and the base 42B. The plurality of white LED illumination units 10B, and the corresponding plurality of light processers 20B and other necessary components are installed in the chamber. A top portion of the housing 40B can be further provided with a decoration housing 43B for adding decorative effect to the LED signal lamp so as to enhance the aesthetic appearance. The housing 40B also comprises a necessary electric wire 44B which is electrically connected to the control center 11B for offering power supply so as to control the operation of the LED signal lamp. The electric wire 44B passes through a sealing panel 45B and is retained in position by sealing glues 46B. The light distributor 41B is sealedly connected via a sealing ring 47B.

Accordingly, the present invention provides an LED signal lamp which comprises one or more light illumination arrangements each comprising a white LED illumination unit 10B, a light processer 20B, and a light reflecting surface 30B. The white LED illumination unit 10B provide white light beams which are filtered by the corresponding the light processer 20B and undergo a light condensing process via the light processer 20B and the light reflecting surface 30B, so that colored signal light beams with high illuminating efficiency are provided. These light illumination arrangements can be arranged to provide radially projecting colored light beams so as to provide a radial signal lighting.

It is worth mentioning that the light processor of this preferred embodiment can be a light condensing device. The LED signal lamp may comprise at least one LED illumination unit and at least one light processor provided in a light path of the LED illumination unit for filtering at least a portion of light beams of the corresponding LED illumination unit before the light beams project to outside.

It is still worth mentioning that when the light process of the present invention is a light condensing device, the LED illumination unit may be embodied as a colored LED illumination unit so that the light processer of the present invention may not need to perform the light filtering step to yield the colored light beams.

When the LED illumination units are white LED illumination units, the light processer is further provided with light filtering effect so as to filter the white light beams of the white LED illumination units to harvest non-white light beams of a predetermined color.

When the light processer is a light filter, the present invention provides a method of manufacturing an LED signal amp which comprises the following steps.

(a′) Project white light beams via at least one white LED illumination unit 10B.

(b′) Filter at least one portion of the white beams to harvest non-white light beams.

The step (a) may further comprise a step (a.1) of: Arrange a plurality of white LED illumination units 10B into a plurality of rows of white LED illumination units 10B in such a manner that the lines of the plurality of rows of white LED illumination units 10B are intersected to form a polygonal shape so as to provide a radial illumination.

In the step (a.1′), each row of the white LED illumination units 10B comprises one or more white LED illumination units 10B.

In the step (a.1′), the lines of the plurality of rows of white LED illumination units 10B are intersected to form a polygonal shape such as an equilateral triangular shape, a square shape, a regular hexagonal shape, a regular octagonal shape, and a regular dodecagonal shape.

The step (b′) may comprise a step (b.1) of providing a light processer 20B in a light path of each of the white LED illumination units 10B, wherein light beams passing through the light processer 20B is filtered to harvest light beams with a predetermined single color.

In the step (b.1′), the light processer can be a Fresnel lens with light filtering effect. The Fresnel lanes may be provided at a location which is capable of condensing light beams so that the light processer 20B performs both light filtering and light condensing effects.

In the step (b.1′), the predetermined color can be red, blue, yellow, green, or purple.

The method may further comprises a step (c) of reflecting another portion of the white light beams via a light reflecting surface 30B in such a manner that the reflected white light beams project in a direction substantially the same as a direction of the light beams which pass through the light processer 20B.

In the step (c′), the light reflecting surface can be a parabolic surface of a light reflecting device or an inner surface of a heat dissipating device 12B.

The method may further comprise a step (d′) of processing the light beams via a light distributor 41B of a housing 40B, wherein the light distributor 41B is an outer lens of a predetermined color, so that the resultant colored light beams are evenly distributed, and the color of the light beams is also enhanced.

The LED signal lamp manufactured by the above method may be a warning lamp (a vehicle emergency lighting), a pharos, ship navigation lighting, a building aero obstruction lighting, or the like.

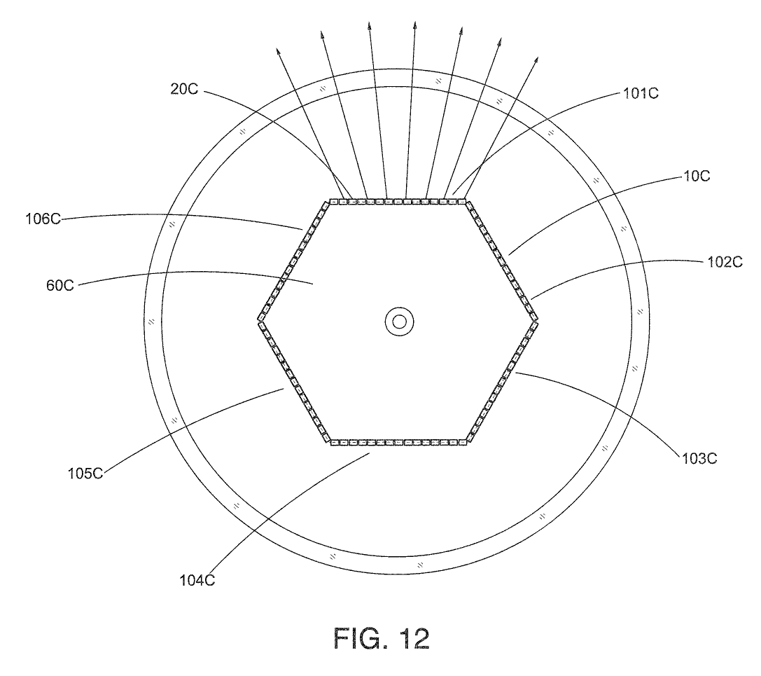

Referring to FIG. 12 of the drawings, an LED signal lamp according to a fourth preferred embodiment of the present invention is illustrated. The LED signal lamp comprises six rows of white LED illumination units 10C each row comprising one or more white LED illumination units 10C. A corresponding light filter 20C is provided in a light path of each white LED illumination unit 10C. The six rows of white LED illumination units 10C are successively arranged in such a manner that the lines of the six rows of white LED illumination units 10C are intersected to from a regular hexagonal shape.

According to this preferred embodiment, the LED signal lamp may further comprise a control module 60C selectively control the operation of each row of the white LED illumination units 10C so as to provide a predetermined pattern of the light beams of the LED signal lamp. In other words, varied lighting effects can be provided by turning on some of the six rows of white LED illumination units 10C while simultaneously turning off some of the six rows of white LED illumination units 10C.

In a specific example, the six rows of white LED illumination units 10C are turned on to flash one by one so that a rotation flash pattern is provided. More specifically, the six rows of white LED illumination units 10C comprises a first row of white LED illumination units 101C, a second row of white LED illumination units 102C, a third row of white LED illumination units 103C, a fourth row of white LED illumination units 104C, a fifth row of white LED illumination units 105C, and a six row of white LED illumination units 106C. The control module 60C can turn on the first row of white LED illumination units 101C to provide light illumination with light beams which are filtered to provide light beams of desired color, so that signal light beams are provided. Then, the control module 60C turns on the second row of white LED illumination units 102C or the sixth row of white LED illumination units 106C which is adjacent to the first row of white LED illumination units 101C while simultaneously turning off the first row of white LED illumination units 101C. The operations can be repeated to provide a counterclockwise or clockwise rotation flash signal lighting. It is worth mentioning that the control module 60C can keep at least one row of white LED illumination units be in the operation state, so that the lighting of the LED signal lamp is not interrupted. The control module 60C may turn on two adjacent rows of white LED illumination units. For example, the first and second rows of white LED illumination units 101C and 102C are firstly turned on for provide a 120° light illumination, and then the third and fourth rows of white LED illumination units 103C and 104C are turned on, and then the fifth and sixth rows of white LED illumination units 105C and 106C are turned on, and the above steps can be repeated The control module may selectively and successively provide a signal light illumination of a predetermined angel range which is 30°, 45°, 60°, 90°, 120°, 180°, or the like.

It is thus can be seen that the varied signal light illumination patterns can be provided via controlling the sequence of the lighting of different rows of white LED illumination units in addition to the above mentioned clockwise or counterclockwise rotation flashing light illumination. For example, one row of the white LED illumination units can be continually turned on or turned off for several times to provide predetermined warning message. As another example, the first and fourth rows of white LED illumination units 101C and 104C are turned on for providing an illumination and then turned off, the second and fifth rows of white LED illumination units 102C and 105C are then turned on for providing an illumination and then turned off, the third and sixth rows of white LED illumination units 103C and 106C are then turned on for providing an illumination and then turned off, the above operations can be repeated so that a different lighting pattern is formed. As yet another example, the first row of white LED illumination units 101C is turned on and maintained for providing the illumination, the second and sixth rows of white LED illumination units 102C and 106C are then turned on, and then turn on the third and fifth rows of white LED illumination units 103C and 105C while keeping the above first, second, and sixth rows of white LED illumination units 101C, 102C, and 106C are also turned on, and then turn on the fourth row of white LED illumination units 104C, finally turn off all rows of white LED illumination units, the above operation steps can be repeated so that another lighting pattern is provided. In other words, varied lighting patterns can be provided through the operation of the white LED illumination units 10C under the control of the control module.

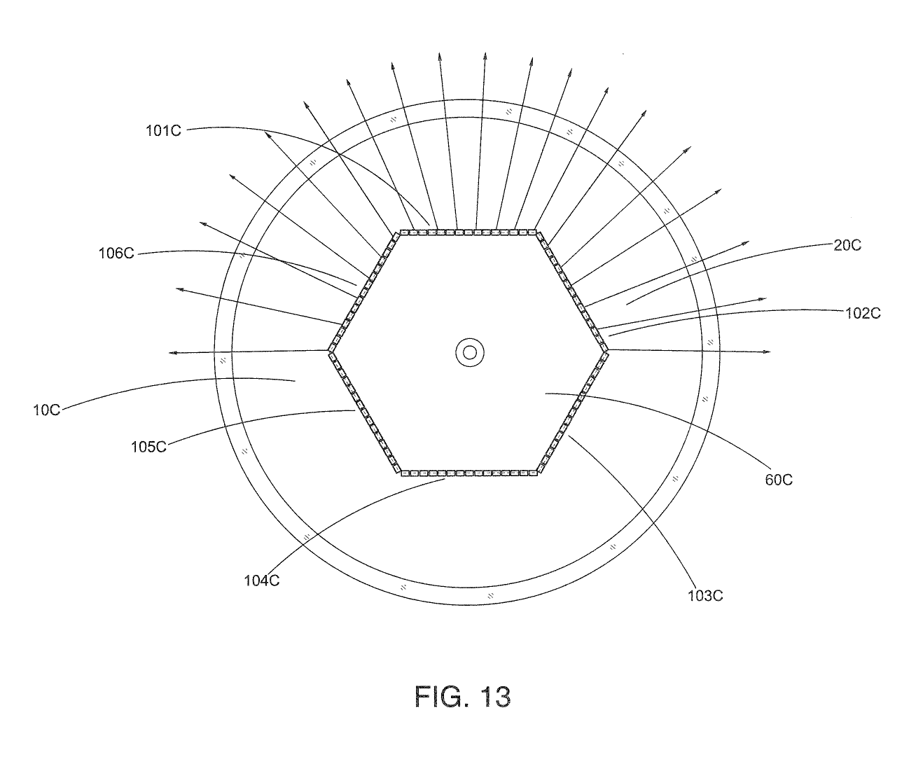

Referring to FIG. 13 of the drawings, an alternative mode of the above preferred embodiment of the present invention is illustrated, the control module 60C may turn on the first, second, and third rows of white LED illumination units 101C, 102C, and 103C to provide a substantially 180° angled light illumination, and then the first, second, and third rows of white LED illumination units 101C, 102C, and 103C are turned off and the fourth, fifth, and sixth rows of white LED illumination units 104C, 105C, and 106C are turned on for provide anther substantially 180° angled light illumination. In other words, the control module 60 may turn on or turn off several rows of white LED illumination units. It is worth mentioning that the light beams of conventional colored illumination units may provide dark areas in the overlapping areas of the light beams. However, when the first, second, and third rows of white LED illumination units 101C, 102C, and 103C are used for providing the light illumination, more specifically, when the first and second rows of white LED illumination units 101C and 102C are turned on and the light beams of the first and second rows of white LED illumination units 101C and 102C are respectively filtered and collected by the corresponding light filters 20C, therein is no relatively dark areas in the overlapping light illumination zone. Similarly, when the second and third rows of white LED illumination units 102C and 103C are turned on and the light beams of the second, and third rows of white LED illumination units 102C, and 103C are respectively filtered and collected by the corresponding light filters 20C, therein is no relatively dark areas in the overlapping light illumination zone. Therefore, the entire light source of the first, second, and third rows of white LED illumination units 101C, 102C and 103C provide an evenly distributed light illumination with a relatively high light intensity.

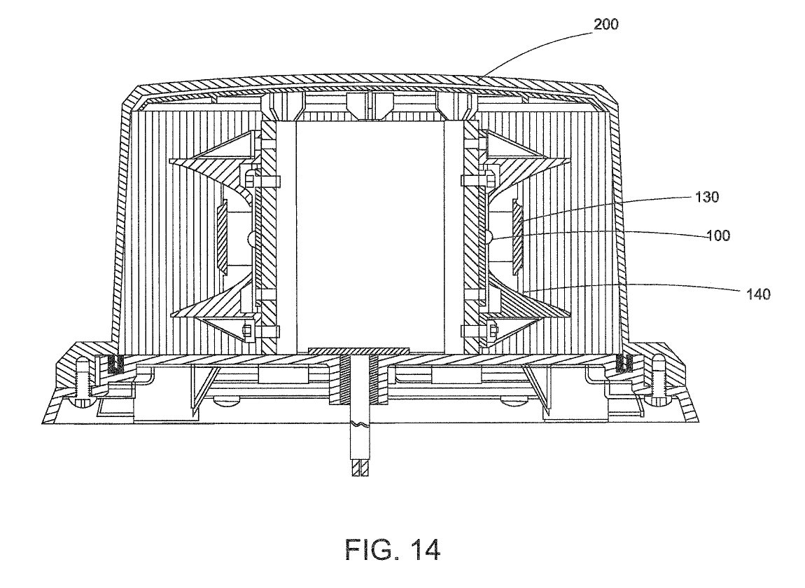

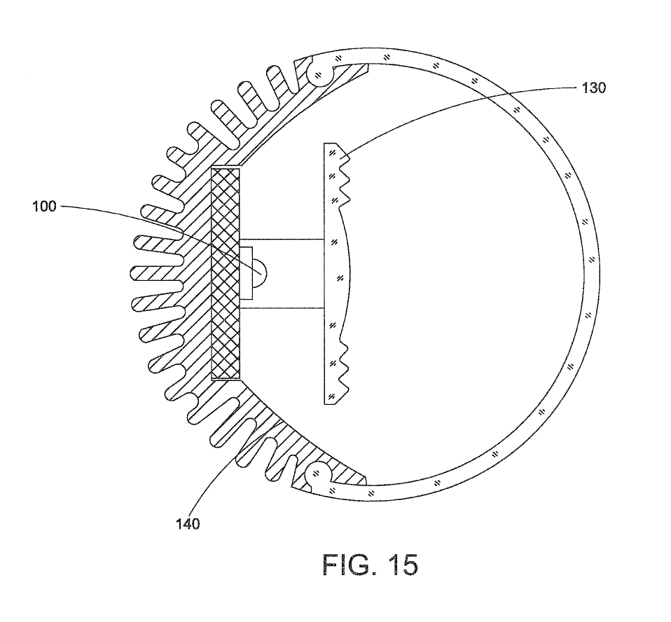

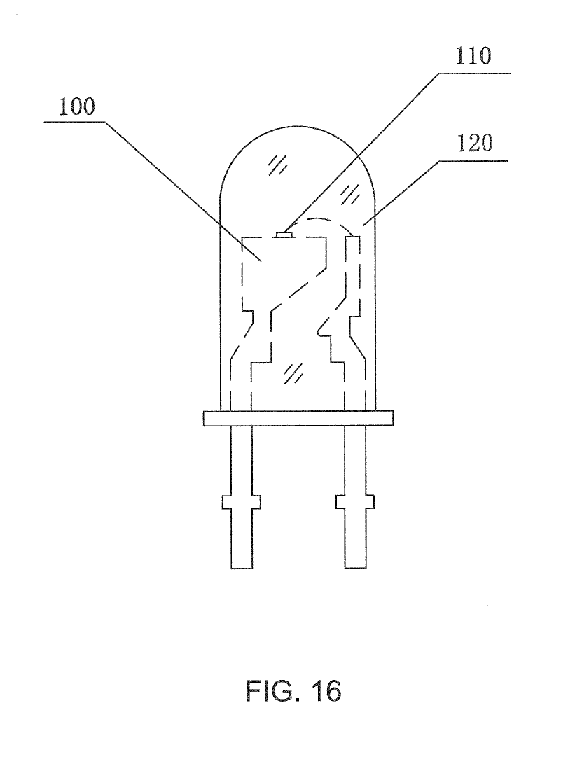

Referring to FIGS. 14 to 16 of the drawings, an LED signal lamp according to a fifth preferred embodiment of the present invention is illustrated. The LED signal lamp comprises an LED light source which comprises one or more LED members 100. The LED signal lamp may further comprise a lamp housing 200 for receiving the one or more LED members 100. The light beams projecting out from each of the LED members 100 are the desired light beams of a predetermined color, so that the desired colored LED signal lamp of the present invention is provided. The lamp housing 200 may have a same structure with the housing 40 of the LED signal lamp according to the above preferred embodiment.

More specifically, each of the LED members 100 is encapsulated with a white LED illumination unit 110. After the encapsulation or package, the white light beams emitting from each of the LED members 100 is filtered to harvest desired colored light beams. Accordingly, a package member 120 of each of the LED members 100 is provided with a color filtering effect, so that the white light beams passing through the package member 120 can be filtered so as to provide desired light beams of a predetermined color.

In other words, regarding each of the LED members 100, which is may be provided with a supporting frame, one or more wires, one or more heat dissipating members, or coated with a fluorescence layer, when after the white LED illumination unit 110 is encapsulated to provide the LED member 100, the light beams projecting out from the LED member 100 become colored light beams of a predetermined color. The material of the package member 120 can be epoxy resin, glass material, silicone material, polycarbonate, polymethyl methacrylate, and so on. However, in comparison with the conventional art, the package member 120 of the present invention is provided with a color filtering effect. In other words, each the LED member 100 of the present invention employs a white LED illumination unit 110 as a light source to provide colored light beams when the white LED illumination unit 110 is encapsulated in the package member 12. This is beyond what the conventional art can provide.

The LED signal lamp of the present invention also may have a similar structure as the LED signal lamp of the above preferred embodiment of the present invention. More specifically, each of the LED members 100 comprises at least one white LED illumination unit 110, and the LED signal lamp further comprises at least one light condenser 130 in the light path of the LED illumination unit 110. The light condenser 130 is provided at a position with respect to the LED member 100 in such a manner that one or more of the light condenser 130 can be creatively designed to perform a light condensing effect. In other words, each of the light condenser 130 can be used to condensing the light beams projecting out from the LED members 100.

Since the light beams projecting out from the LED members 100 are desired light beams of a predetermined color, so that the light condenser 130 is different from the above light filter 20, for the light condenser 130 only performs the light condensing effect without need to filter the white light beams.

Each of the light condensers 130 can be a lens which can provide a light condensing effect, such as a convex lens. Accordingly, as an example, each of the light condensers 130 can be a Fresnel lens, so that the light beams of each LED member 100 are collected and focused, so as to project substantially in parallel directions, so that the light efficiency is increased. The predetermined areas, where the light beams reach to, can have a relatively high luminous flux. Accordingly, each of the LED members 100 may be provided with one light condenser 130. Alternatively, a plurality of light condensers 130 is formed into an integral structure for condensing light beams emitting is from the plurality of LED members 100.

Similarly, each of the white illumination unit 110 of the LED member 100 is provided within a receiving cavity defined by a light reflector 140. The light reflector 140, together with the light condenser 130, collects and condenses the light beams emitting from the white illumination unit 110 of the LED member 100. The light beams reflected by the light reflector 140 and the light beams passing through the light condenser 130 are condensed so as to substantially project along parallel directions. Accordingly, the light reflector 140 may be spacedly aligned with the light condenser 130 so that a gap may be formed therebetween allowing a portion of light beams to pass therethrough so as to reach the light reflector 140 and finally be reflected on the light reflector 140. The light condenser 130 does not perform a light condensing effect for this portion of light beams passing through the gap between the light condenser 130 and the light reflector 140.

Therefore, the introduction of the LED members 100 of this preferred embodiment is able to provide colored light beams of a desired predetermined color. When a plurality of LED members 100 is arranged in a plurality of rows each comprising one or more of the LED members 100, LED signal lamps which can provide an illumination to areas of different angle ranges or of different shapes can be provided.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

1-28. (canceled)

29. An LED signal lamp, comprising:
at least one white LED illumination unit, and
at least one light filter each is provided in a light path of each of said white LED illumination unit for filtering at least one portion of light beams of said white LED illumination unit to provide non-white light beams of a predetermined color.

30. The LED signal lamp, as recited in claim 29, wherein said light filter is provided at a position in said light path of each of said white LED illumination unit allowing said light filter to perform a light condensing function, wherein said light filer is capable of providing both a light filtering effect and a light condensing effect.

31. The LED signal lamp, as recited in claim 30, wherein said light filter comprises a lens which is capable of condensing light beams.

32. The LED signal lamp, as recited in claim 29, wherein said LED signal lamp is further provided with at least one light reflecting surface for reflecting another portion of light beams of said corresponding white LED illumination unit.

33. The LED signal lamp, as recited in claim 31, wherein said LED signal lamp is further provided with at least one light reflecting surface for reflecting another portion of light beams of said corresponding white LED illumination unit

34. The LED signal lamp, as recited in claim 33, wherein said another portion of light beams of said white LED illumination unit reflected by said light reflecting surface and said portion of said light beams of said white LED illumination unit filtered by said light fitter project in a same direction, so that a light condensing effect is provided.

35. The LED signal lamp, as recited in claim 34, wherein said light reflecting surface is a structure selected from a group consisting of a first structure and a second structure, wherein in said first structure, each of said white LED illumination units is provided with a light reflecting device, wherein said light reflecting surface is an inner surface of said light reflecting device, wherein in said second structure, each of said white LED illumination units is provided with a heat dissipating device, wherein said light reflecting surface is an inner surface of said heat dissipating device.

36. The LED signal lamp, as recited in claim 35, wherein said LED signal lamp further comprises a housing which includes a light distributor allowing light beams of predetermined color to pass through.

37. The LED signal lamp, as recited in claim 36, wherein said light distributor is further used for distributing a direction of said light beams.

38. The LED signal lamp, as recited in claim 37, wherein at least one mounting element is provided for mounting said each of said light filters and said corresponding heat dissipating device and said light distributor in position.

39. The LED signal lamp, as recited in claim 35, wherein said predetermined color is selected from a group consisting of red, blue, yellow, green, and purple.

40. The LED signal lamp, as recited in claim 35, wherein said light filter is selected from a group consisting of a convex lens and a Fresnel lens which is capable of providing a light filtering effect.

41. The LED signal lamp, as recited in claim 40, wherein said light filter is selected from a group consisting of a vehicle emergency lighting, a warning lamp, a pharos, a ship navigation lighting, and a building aero obstruction lighting.

42. The LED signal lamp, as recited in claim 29, wherein said LED signal lamp comprises a plurality of said white LED illumination units, wherein said plurality of white LED illumination units are arranged to form a plurality of rows of white LED illumination units, wherein lines of said plurality of rows of white LED illumination units are intersected to form a polygonal shape, wherein each row of white LED illumination units comprises one or more of said white LED illumination units.

43. The LED signal lamp, as recited in claim 31, wherein said LED signal lamp comprises a plurality of said white LED illumination units, wherein said plurality of white LED illumination units are arranged to form a plurality of rows of white LED illumination units, wherein lines of said plurality of rows of white LED illumination units are intersected to form a polygonal shape, wherein each row of white LED illumination units comprises one or more said white LED illumination units.

44. The LED signal lamp, as recited in claim 41, wherein said LED signal lamp comprises a plurality of said white LED illumination units, wherein said plurality of white LED illumination units are arranged to form a plurality of rows of white LED illumination units, wherein lines of said plurality of rows of white LED illumination units are intersected to form a polygonal shape, wherein each row of white LED illumination units comprises one or more of said white LED illumination units.

45. The LED signal lamp, as recited in claim 42, wherein said LED signal lamp further comprises a control module arranged for selectively turning on and turning off said plurality rows of white LED illumination units so as to provide a predetermined signal lighting pattern of said LED signal lamp.

46. The LED signal lamp, as recited in claim 45, wherein said control module selectively clockwise and counterclockwise turns on said plurality of rows of white LED illumination units to provide a flashing lighting effect.

47. The LED signal lamp, as recited in claim 42, wherein said control module controls to have at least one row of white LED illuminating units of said plurality of rows of white LED illuminating units being turned on so as to keep the signal lighting of said LED signal lamp being not interrupted.

48. The LED signal lamp, as recited in claim 42, wherein said control module control the operation of said plurality of rows of white LED illumination units to provide an illumination of an angle range selectively from a group consisting of 30°, 45°, 60°, 90°, 120°, and 180°.

49. A method of manufacturing an LED signal lamp, comprising the following steps:
(a) projecting white light beams via at least one white LED illumination unit; and
(b) filtering at least one portion of the white beams to harvest non-white light beams.

50. The method, as recited in claim 49, wherein the step (b) further comprises a step (b.1): providing a light filter in a light path of each of said white LED illumination units, wherein light beams passing through said light filter is filtered to harvest light beams with a predetermined single color.

51. The method, as recited in claim 50, wherein in the step (b.1), said light filter is a Fresnel lens which is capable of providing a light filtering effect, wherein said Fresnel les is provided at a location which is capable of condensing light beams.

52. The method, as recited in claim 51, wherein said predetermined color is selected from a group consisting of red, blue, yellow, green, and purple.

53. The method, as recited in claim 52, wherein the method further comprises a step (c): reflecting another portion of said white light beams via a light reflecting surface.

54. The method, as recited in claim 53, wherein said another portion of said white light beams which is reflected by said light reflecting surface projects in a direction substantially the same as a direction of light beams which have passed through said light filter.

55. The method, as recited in claim 54, wherein the method further comprises a step (d): processing said light beams via a light distributor of a housing, wherein said light distributor is an outer lens of a predetermined color, so that resultant colored light beams are evenly distributed, and a color of said light beams is also enhanced.

56. The method, as recited in claim 55, wherein said light distributor is further arranged for adjusting a direction of said light beams.

57. An LED signal lamp, comprising: at least one LED member serving as a light source, wherein each of said LED members comprises at least one white LED illumination unit, wherein said white LED illumination unit is packaged in the corresponding LED member in such a manner that light beams projecting out from said LED member are light beams of a predetermined color other than white, so that said LED signal lamp is capable of providing desired colored light beams.

58. The LED signal lamp, as recited in claim 57, wherein each of said white LED illumination unit is provided with a transparent package member which has a color filtering effect, wherein white light beams emitting from said white LED illumination unit are filtered by said corresponding colored transparent package member so as to harvest light beams of said predetermined color.

59. The LED signal lamp, as recited in claim 58, further comprising at least one light condenser and at least one light reflector, wherein said light condenser is provided at a position in a light path of said LED member in such a manner that said light condenser is capable of providing a light condensing effect, wherein a portion of said light beams projecting out from said LED members is reflected by said light reflector, wherein another portion of said light beams projecting out from said LED members is condensed by said light condenser, wherein both of said first and second portion of said light beams projecting out from said LED members are collected to substantially project along a same direction, so that a light collecting effect is provided.
